(19) United States
(12) Patent Application Publication
(10) Pub. No.: US 2008/0109480 A1
(43) Pub. Date: May 8, 2008

(54) RELATIONSHIP MANAGEMENT FOR MARKETING COMMUNICATIONS

(76) Inventors: David Brophy, Victoria (AU); Christian Seifert, Durham, NC (US); David Carmer, Cary, NC (US); Jason Figge, Pittsboro, NC (US); Harold Lee, Holly Springs, NC (US); Jennifer Baldwin, Apex, NC (US)

Correspondence Address: JAMES M. STOVER;TERADATA CORPORATION, 2835 MIAMI VILLAGE DRIVE, MIAMISBURG, OH, 45342, US

(21) Appl. No.: 11/555,853

(22) Filed: Nov. 2, 2006

(51) Int. Cl. G06F 17/30

(52) U.S. Cl. 707/104.1; 707/E17.045

(57) ABSTRACT

Techniques are presented for managing relationships during communications of marketing activities. Contacts associated with a target of a communication during a marketing activity are expanded in accordance with contact rules. The manners in which the communication is handled with respect to the target and the expanded contacts are driven by treatment rules.

### FIELD

The invention relates generally to data store processing and more particularly to techniques for managing relationships during marketing communications.

### BACKGROUND

Enterprises are finding it increasingly easier to reach their customers with technology advancements. For example, the Internet and the World-Wide Web (WWW) has enabled enterprises to deliver information related to their goods and services to their customers 24 hours a day and all year long.

In addition, enterprises can now reach their customer through a plethora of communication channels. For example, marketing information can be delivered via electronic mail, via a WWW site, via traditional phone lines, via on demand television, via traditional postage mail, via cell or satellite phones, via traditional advertisements, via Instant Messaging (IM), and the like.

One drawback to the advances in technology is that customers are becoming so inundated with sales pitches, which occur over multiple communication channels, that they have largely tuned out or ignored the sales pitches. This is especially true if the customers believe the sales pitches are becoming too excessive and too intrusive in their daily lives. In fact, too many sales pitches can lead to negative reputations for some enterprises, such that even attractive goods and services offered by that enterprise are discounted and ignored by the beleaguered customers.

Enterprises have also assembled large amounts of transactional data and customer information related to their business activities. This information is often stored and indexed in databases that the enterprises mine and analyze in efforts to expand their business activity or enhance customer-relationship management (CRM).

However, enterprises have yet to figure out a way that this captured information can be integrated in an automated fashion for purposes of driving customer communications in an effort to improve the deteriorating customers' opinions about the enterprises' marketing efforts.

Thus, it can be seen that improved techniques for managing marketing communications, are desirable.

### SUMMARY

In various embodiments, techniques for managing relationships during communications occurring with marketing activities are presented. According to an embodiment, a method for managing relationships during a communication of a marketing campaign is taught. Contacts associated with a target are expanded for a communication of a marketing campaign in response to contact rules. The communication is managed during the marketing campaign with respect to the target and the contacts using treatment rules.

### BRIEF DESCRIPTION OF THE DRAWINGS

FIG. 1 is a diagram of a method for managing relationships during a communication, according to an example embodiment.

FIG. 2 is a diagram of a method for processing a communication associated with a marketing activity, according to an example embodiment.

FIG. 3 is a diagram of a relationship management communication system, according to an example embodiment.

### DETAILED DESCRIPTION

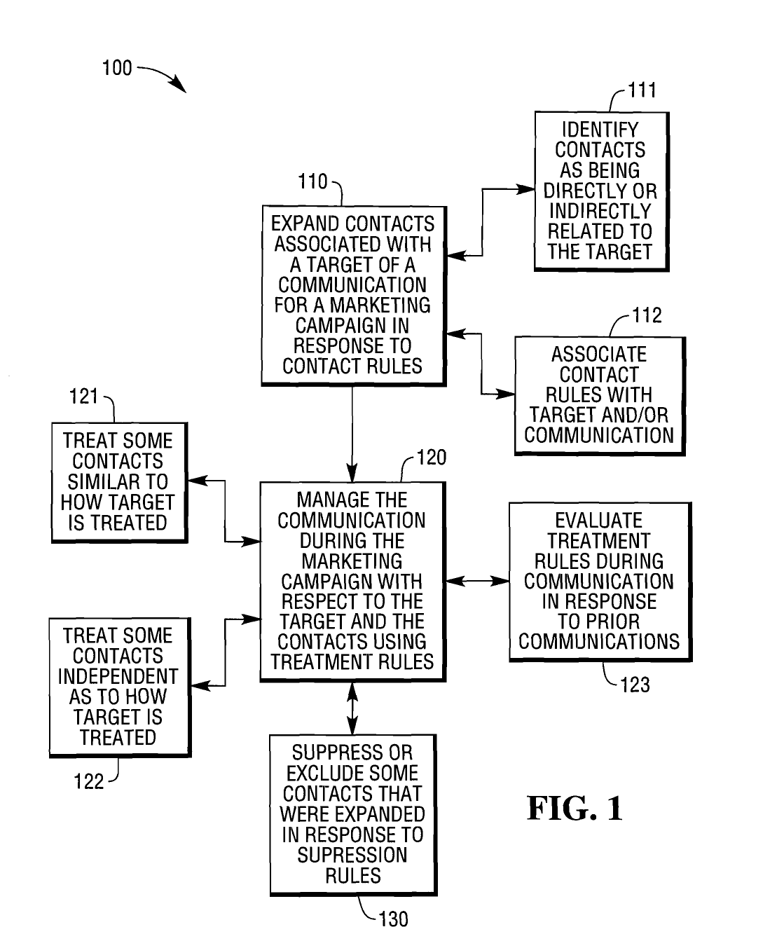

FIG. 1 is a diagram of a method 100 for managing relationships during a communication associated with a marketing campaign, according to an example embodiment. The method 100 (hereinafter “relationship management service”) is implemented in a machine-accessible or computer-readable medium as instructions that when executed by a machine (processing device) performs the processing depicted in FIG. 1. Moreover, the relationship management service is optionally accessible over a network. The network may be wired, wireless, or a combination of wired and wireless.

A “data store” as used herein may include a database, a collection of databases organized as a data warehouse, a directory, a collection of directories cooperating with one another, or various combinations of the same. According to an embodiment, the data store is a Teradata® warehouse product or service distributed by NCR Corporation of Dayton, Ohio.

The data store includes a variety of enterprise information. One type of information is referred to as an “entity.” An entity is something that can be uniquely identified (e.g., a customer account, a customer name, a household name, a logical grouping of certain types of customers, etc.).

“Related entities” are entities that have relationships that are identified in the data store as having local associations with one another. For example, an account identifier may have an association within the data store to a particular customer name and that particular customer name may belong to a particular household.

A “related set” of entities is a group of entities that can be managed by the relationship management service as single holistic set for a marketing campaign or a marketing activity.

A related set may include a variety of entity designations for various entities included within the related set. For example, a “target” is an entity that a marketing activity or a communication is directed to. In other words, a target is the object of a communication or a marketing activity. For example, an account that is selected as a candidate for communication during a marketing campaign may be viewed as the “target” entity for the communication. Entities may also be viewed as “directly related.” Directly related entities are directly related to a target of a communication. This may include the account holders (e.g., customer names, etc.).

Entities can also be indirectly related to the target. For example, household members from the same household as the individuals who hold target accounts may be viewed as being indirectly related to the target accounts and the individuals that hold the accounts (directly related to the target accounts).

Entities within a related set may be treated as homogenous sets where all the entities within the related set are treated in a consistent or perhaps same manner. Entities within the related set may also be treated as independent sets where all the entities within the related set can be treated independent of one another.

According to an embodiment, the related sets may be defined using Teradata® segmentation capabilities. The functionality to define these related sets of entities includes options to define whether rows in the related set should be de-duplicated against primary targets (i.e., does the user want the primary targets excluded from the related set) and to govern whether a primary target is impacted if a related entity is found in a suppression list or gets assigned to a control group. Moreover, related entities are represented in a segment by semantic elements. These semantic elements need not be in the same semantic, in which case a cross semantic relationship is established. Directly and indirectly related elements may be derived off of different semantic element types. This is so because in each segment there is only one field of each semantic element and the target entity already occupies that field.

A “communication” is a message, advertisement, survey, sales pitch, offer, etc. that is directed to a target of a marketing campaign. The communication may be over any available or desired communication channel, such as but not limited to email, IM, WWW, phone, on-demand television, etc. The marketing campaign may identify the type of communication and the communication channel. Moreover, a single communication may be processed to a target during a marketing campaign over a plurality of different communication channels.

The relationship management service uses contact rules and treatment rules to process communications to targets of communications and to contacts associated with the targets of those communications.

Each communication may be associated with one or more “contact rules.” A contact rule may consider prior communications made to a particular target or contacts (related entities) associated with the target. Moreover, a contact rule may ignore previous communications made to a target or the contacts of the target for any given marketing campaign and communication associated with the marketing campaign.

A “treatment rule”is used by the relationship management service to manage the target of a communication. For example, a target of a communication may have a treatment rule that indicates that the communication being directed to the target should be identically made to directly related entities or contacts associated with the target. In another example, a treatment rule may be used to treat indirectly related entities of a target in an independent manner.

As an example, consider a communication that targets an offer to individuals (target entities) who hold a certain type of account with an enterprise. This account may be jointly held by multiple individuals (such as a spouse) associated with the target individual. In such a situation, the relationship management service may apply a treatment rule that all joint account holders of the target individuals must receive the same offer. If any individual who is a joint account holder fails any optimization rule or is suppressed due to a marketing exclusion in the marketing campaign or falls into a control group, then the offer must not be sent to any of the other joint account holders for that account.

In another example, consider that secondary messages can be sent to indirectly related entities in support of a primary message communication to the target and/or any directly related entities. For example, suppose a communication is an offer to a target individual within a household who has a certain type of service (such as cell phone service). Other individuals within the same household may also be eligible for the same or similar service. The offer is sent to the target individual and at the same time a treatment rule indicates that this is also an opportunity to send a secondary information packet about the offered service to all other members of the household who are eligible for the service. If a targeted individual cannot be delivered the primary offer (due to optimization rules, suppression rules, etc.) then secondary information packets must not be sent to any related entities. If any particular secondary information packet cannot be delivered, the primary offer and the other remaining secondary information packets can still be delivered.

Thus, the treatment rule may be used to treat targets of communications in a same manner as other contacts or may be used to treat the target and the other contacts in independent manners.

In some cases, the contacts (related entities) of targets may be custom-defined by the targets. Additionally, the contact rules and the treatment rules may in some cases be, at least partially, defined by the targets.

In this manner, and as will be more clearly defined herein and below, enterprises may now apply each individual customer's relationships as household members, joint account holders, small business customers, members of voluntary organizations, etc. for purposes of providing greater insight into each individual's complete association with their organization and therefore optimize the effectiveness of the targeting and treatment of customers throughout the marketing process.

It is within this context that the processing of the relationship management service is now discussed with reference to the FIG. 1. At 110, the relationship management service expands contacts (entities—related sets, directly related and indirectly related), which are associated with a target entity (hereinafter referred to as “target”). The contacts are expanded for a given communication being used in a marketing campaign or marketing activity. The expanded contacts are resolved using relationships defined in contact rules.

According to an embodiment, at 111, the contacts may be identified as being directly related or indirectly related. The definition of what is considered to be “directly related” and what is considered to be “indirectly related” was supplied above.

In some cases, at 112, the relationship management service may associate the contact rules with either the target of the communication or with the communication as a whole. That is, the contact rules may be associated with an individual target or may be associated with a communication or with the marketing campaign as a whole. In some cases, the contact rules can be associated with the target, the communication, and even perhaps the marketing campaign.

At 120, the relationship management service proceeds to manage in real time or dynamically the communication during the marketing campaign for the target and the contacts using treatment rules. In an embodiment, at 121, the relationship management service may elect to treat some contacts in a similar or consistent manner with how the target is treated. So, as was discussed by way of example above, a target may have a treatment rule where all joint account holders are to be treated the same as the target for the communication. Thus, if the target cannot be sent a communication, such as an offer, then the contacts cannot be sent the communication or any related communication.

In other cases, at 122, the relationship management service may use the treatment rules to treat some contacts in an independent fashion from how the target or other ones of the contacts are treated. Again, and as was presented above in the prior examples on this point, the relationship management service may elect to send secondary information packets or communications to members of a same household even if some of the household members are unreachable.

In still another situation, at 123, the relationship management service may evaluate treatment rules during the communication in response to prior communications. So as an example, if a prior communication contacted a spouse of the target, then a treatment rule may be set up such that the spouse is not contacted for this particular communication in an effort to not over contact that spouse. Prior communications may be used to drive the evaluation of the treatment rules. However, it is noted that in some cases the prior communications do not have to be considered when evaluating and enforcing current treatment rules for current processing communications.

In still another case, at 130, the relationship management service may actually be used to suppress some contacts that were previously expanded in response to suppression rules. For example, a particular target may forbid that a particular contact be communicated with. In such a situation, suppression rules may be used to override normal processing and ensure that such contacts are not communicated with. There may also be legal reasons for suppressing some contacts, such as when contacts are on federal no call lists, have specifically opted out of email communications, etc.

As an example of how a communication may be processed, consider a marketing campaign where a group of target entities are identified for a communication, such as an offer for purchasing online music. Once the target entities are acquired using segmentation plans associated with the marketing campaign, the relationship management service may be used to expand the contacts for the targets into a related sets of other contacts, some of which are directly related and some of which are indirectly related; this can be done using contact rules for the targets, and/or the communication. Next, the contacts may be filtered or suppressed out using suppression rules, optimization rules, or if identified as being part of a control group. Finally, the treatment rules are used to process the communication and any related communications to the targets and the expanded contacts. Some contacts may be treated the same as the targets and other contacts may be treated independent of remaining contacts and perhaps the targets.

It is now understood how communication with customers may be more intelligently achieved in an automated fashion using contact rules and treatment rules. The relationship management service expands and filters contacts for a communication using the contact rules. Moreover, the relationship management service uses the treatment rules to drive the processing of the communication. Now enterprises can treat contacts of communications in manners that are more conducive to how these contacts like or want to be contacted or in manners required by prevailing laws. This is less intrusive and provides more opportunities for enterprises to better manage relationships between and amongst contacts of a marketing campaign or marketing activity.

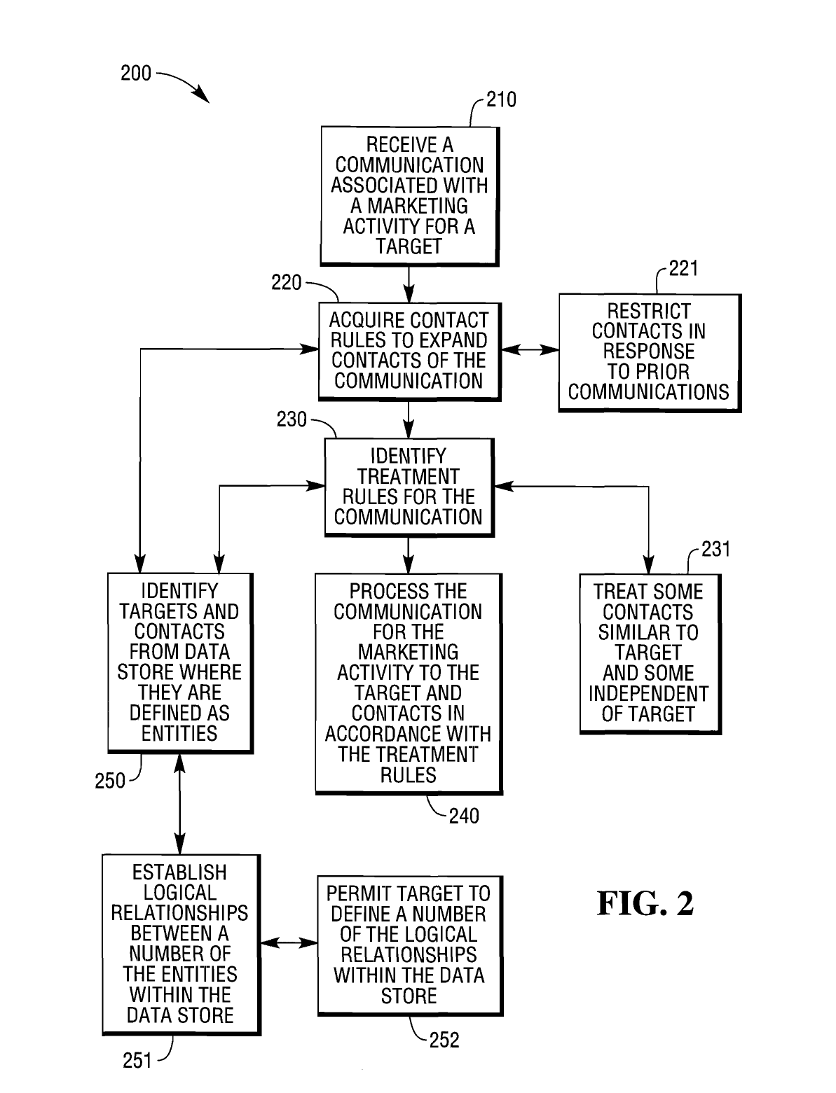

FIG. 2 is a diagram of a method 200 for processing a communication associated with a marketing activity, according to an example embodiment. The method 200 (hereinafter “contact and treatment service”) is implemented in a machine-accessible and readable medium as instructions that when executed by a machine performs the processing reflected in FIG. 2. The contact and treatment service may also be accessible over a network. The network may be wired, wireless, or a combination of wired and wireless. The contact and treatment service presents an alternative processing perspective to the relationship management service represented by the method 100 of the FIG. 1.

At 210, the contact and treatment service receives a communication associated with a marketing activity. The communication is directed to one or more target entities (target). The communication may be over any desired communication channel or over a variety of disparate communication channels. Moreover, the communication may be an offer, a survey, a coupon, an announcement of a new good or service, an upgrade, etc.

At 220, the contact and treatment service acquires contact rules to expand the contacts to be used with the communication. In some cases, at 221, this may entail restricting the contacts or filtering the contacts in response to evaluation of prior communications with those contacts.

At 230, the contact and treatment service also identifies one or more treatment rules for the communication. The treatment rules define or drive how and to whom the communication or any related secondary communication transpires for the marketing activity. So, at 231, some contacts may be treated in a homogeneous manner or similar manner with how the target of the communication is being treated with the communication. In other cases, at 231, some contacts may be treated in an independent manner from how the target or other ones of the contacts are being treated with the communication. Examples of these two scenarios were discussed in detail above.

At 240, the contact and treatment service processes the communication for the marketing activity to the target and to the contacts in accordance with the treatment rules. That is, the treatment rules drive how and to whom the communication and any secondary related communications are processed for the marketing activity.

According to an embodiment, at 250, the contact and treatment service may identify the targets and the contacts from a data store, such as a data warehouse (e.g., Teradata® distributed by NCR Corporation of Dayton, Ohio, etc.). To do this, the contact and treatment service may recognize established relationships in the data store between a number of the entities within the data store. The entities include the target and the expanded contacts and the relationships are linkages within the data store that logically associate the target and the contacts with one another.

In some cases, at 252, the target may be permitted to custom-define a number of the logical relationships within the data store. So, the target or even the contacts themselves may be able to supply information that is used to define the relationships within the data store.

In this manner, the targets and contacts are treated in manners that they expect and desire and these relationships are captured in the data store and enforced by the contact and treatment service for any particular communication associated with a marketing activity being processed by an enterprise.

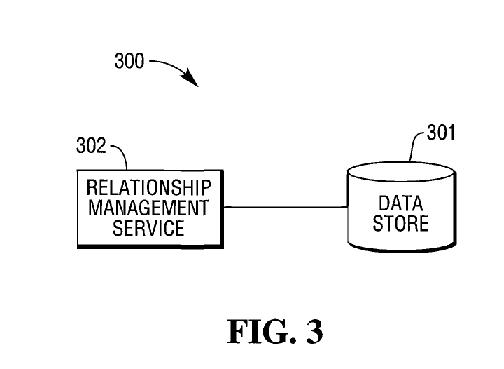

FIG. 3 is a diagram of a relationship management communication system 300, according to an example embodiment. The relationship management communication system 300 is implemented in a machine-accessible and readable medium and is operational over a network. The network may be wired, wireless, or a combination of wired and wireless. In an embodiment, portions of the relationship management communication system 300 implements, among other things the relationship management service and contact and treatment service represented by the methods 100 and 200 of the FIGS. 1 and 2, respectively.

The relationship management communication system 300 includes a data store 301 and a relationship management service 302. Each of these will now be discussed in turn.

The data store 301 may be a directory, a database, a data warehouse, or a collection of these items. The data store 301 includes a variety of logically organized information and an interface that permits the information to be updated, deleted, created, and obtained (such as via a query language (SQL, etc.).

The data store 301 is used to define entities where depending on any given communication being processed for a marketing activity, one or more entities are designated as primary targets for the communication and other ones of the entities may be designated as expanded contacts related directly or indirectly to the primary targets. It is noted that the designation as to what is considered a primary target and what is considered an expanded related contact is dependent upon the communication and what query or segmentation plan that was processed to acquire the primary targets for the communication. The targets are the primary objectives of the communication or the marketing activity.

The entities within the data store 301 are selectively associated with one another in logical and many-to-many relationships. These relationships can be traversed by querying the data store 301 once a primary target is designated for purposes of determining and identifying the expanded contacts associated with the primary target.

The data store 301 may also be used to house and associate contact rules and treatment rules. The contact rules may be associated with a particular entity within the data store 301, associated with a particular communication, and/or associated with the marketing activity as a whole. For example, a contact rule for a primary target may identify a particular household and particular members of that household. In another example, a contact rule may identity a small business or an association and its members for a given primary target.

The treatment rules are used to define how the communications are processed from marketing activities. Treatment rules may also be used to define that the targets and the expanded contacts are to be treated in same or consistent manners or treated in independent manners from one another. Examples of these situations were discussed above with reference to the methods 100 and 200 of the FIGS. 1 and 2.

The relationship management service 302 interacts with the data store 301 and services that process a marketing activity. The relationship management service 302 queries the data store 301 to acquire primary targets for a given communication of a given marketing activity. Next, contact rules are acquired and used to expand the contacts for the communication. The relationship management service 302 then acquires treatment rules for the communication and marketing activity. The treatment rules are then used to drive the processing of the communication to the target and to the expanded contacts.

Example processing associated with the relationship management service 302 was presented above with reference to the method 100 and 200 of the FIGS. 1 and 2, respectively.

It is now understood how relationships may be managed for marketing communications in an automated manner that takes advantage of contacts and their relationships with one another. This permits legal compliance in areas where legal issues arise and permits customers to be handled in manners that they expect, that makes sense to them, and that takes advantage of the knowledge store of an enterprise.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
expanding contacts associated with a target for a communication of a marketing campaign in response to contact rules; and
managing the communication during the marketing campaign with respect to the target and the contacts using treatment rules.

2. The method of claim 1, wherein expanding further includes identifying some contacts as being directly related to the target and some other contacts as being indirectly related to the target.

3. The method of claim 1 further comprising, associating the contact rules with at least one of the communication and the target.

4. The method of claim 1, wherein managing further includes treating a number of the contacts during the communication in a same manner as the target is treated.

5. The method of claim 1, wherein managing further includes treating a number of the contacts during the communication in a manner that is independent from how the target is treated.

6. The method of claim 1, wherein managing further includes evaluating the treatment rules during the communication in response to information associated with one or more prior communications for the contacts and the target.

7. The method of claim 1 further comprising, suppressing or excluding a number of the contacts that were expanded in response to suppression rules.

8. A method, comprising:
receiving a communication associated with a marketing activity for a target;
acquiring contact rules to expand contacts of the communication;
identifying treatment rules for the communication; and
processing the communication for the marketing activity to the target and the contacts in accordance with the treatment rules.

9. The method of claim 8, wherein acquiring further includes restricting the contacts in response to one or more prior communications.

10. The method of claim 8, wherein processing further includes treating a number of the contacts as the target is treated for the communication.

11. The method of claim 8, wherein processing further includes treating a number of the contacts independently from how the target is treated for the communication.

12. The method of claim 8 further comprising, identifying the target and the contacts from a data store, wherein the target and the contacts are entities defined within the data store.

13. The method of claim 12 further comprising, establishing logical relationships between a number of the entities within the data store.

14. The method of claim 13 further comprising, permitting the target to define a number of the logical relationships within the data store.

15. A system comprising:
a data store; and
a relationship management service, wherein the relationship management service is to manage communications for a marketing activity by acquiring expanded contacts for targets of the communications from the data store in response to contact rules, and wherein the relationship management service is to direct the communications to the targets and the expanded contacts in response to treatment rules.

16. The system of claim 15, wherein the data store defines entities and the entities are identified as the targets and the contacts for the communications, and wherein the targets are primary objectives of the marketing activity.

17. The system of claim 16, wherein the entities are selectively associated with one another in logical and many-to-many relationships defined in the data store.

18. The system of claim 15, wherein the data store also includes the contact rules and the treatment rules.

19. The system of claim 15, wherein a number of the treatment rules instruct the relationship management service to treat the expanded contacts of the communications in same manners as the targets are treated for the communications.

20. The system of claim 15, wherein a number of the treatment rules instruct the relationship management service to treat the expanded contacts of the communications in independent manners from how the targets are treated for the communications.
